(19) United States
(12) Patent Application Publication
(10) Pub. No.: US 2018/0104750 A1
(43) Pub. Date: Apr. 19, 2018

(54) FEEDBACK-CONTROLLED SYSTEM FOR CYROGENICALLY COOLING MACHINING TOOLS

(71) Applicant: United Technologies Corporation, Farmington, CT (US)

(72) Inventors: Glenn Levasseur, Colchester, CT (US); Gordon Miller Reed, Plantsville, CT (US); Krzysztof Barnat, Berlin, CT (US)

(21) Appl. No.: 15/296,609

(22) Filed: Oct. 18, 2016

(51) Int. Cl. B23C 5/28; B23Q 11/12

(52) U.S. Cl. CPC B23C 5/28; B23Q 11/126

(57) ABSTRACT

Disclosed is an improved method for cryogenically cooling machining tools where a feedback-controlled system uses temperature, pressure, flow and/or infrared sensors to regulate flow of a cryogenic coolant and functioning of a cutting tool.

### BACKGROUND

Machining techniques take a raw material, called a work piece, and form it into a final, desired shape through a controlled material-removal process. Modern machining processes use a variety of cutting tools to shape work pieces, including drills, turning inserts, endmills, taps, threadmills, and others. These various tools can be used for machining such as turning, milling, hole making, cutting and other shaping processes.

As cutting tools are used in machining processes, they are worn down. Over time, the application of cutting tools to work pieces dulls the tools. This is caused in part by the heat and friction created where the tool meets the work piece. Thus, cutting tools are often cooled to increase tool longevity.

One such method of cooling cutting tools is cryogenic cooling. These methods utilize cryogenic coolants, such as liquid nitrogen or carbon dioxide, to cool the tool. Standard apparatuses for cryogenic cooling are commercially available. Some cryogenic machining systems run a coolant through the cutting tool. In contrast, other machining technology provides an external cooling scheme that applies coolant to the surface of the cutting tool. Both types of commercially available systems cool a tool used in machining methods.

These methods offer no way to monitor how efficiently the cutting tool is being cooled by the cryogenic coolant. Neither do these methods provide any information on whether a cutting tool has dulled too much to be used, nor do these methods provide information on the state of the cryogenic fluid used in the process. Generally, these methods allow the cutting tool to be used until it no longer works, and allow users to only assess the cutting tool's condition in a qualitative, trial and error method. This causes error in work pieces when the cutting tool has deteriorated, and does not efficiently use cryogenic coolants.

### SUMMARY

A cryogenic machining system includes a cryogenic fluid source, a flow regulator downstream of the cryogenic fluid source, a machining control unit, at least one sensor downstream of the flow regulator, configured to assess cryogenic fluid and transmit data to the machining control unit, and a cutting tool downstream of the at least one sensor.

A method of regulating a cryogenically cooled machining system includes flowing a cryogenic coolant through a flow regulator; directing the cryogenic fluid through at least one sensor; assessing at least one property of the cryogenic fluid with the at least one sensor; cooling a cutting tool with the cryogenic coolant; transmitting data about the at least one property of the cryogenic fluid from the sensor to a machining control unit; and adjusting at least one property of the cryogenic coolant based on the data transmitted to the machining control unit.

### BRIEF DESCRIPTION OF THE DRAWINGS

FIG. 1 is a schematic diagram of a feedback-controlled cryogenic machining system.

FIG. 2 is a flow diagram of a method of executing a feedback-controlled cryogenic machining system.

### DETAILED DESCRIPTION

The disclosed system allows for a quantitative analysis of the state of a cutting tool and the cryogenic coolant flowing to a cutting tool. A feedback-controlled system provides data and information on the cutting tool and the cryogenic coolant not previously collected in machining systems. This information allows for modification of the cryogenic cooling machining system to create longer tool life, improved workpiece metallurgy and surface finish, and more efficient use of cryogenic coolants.

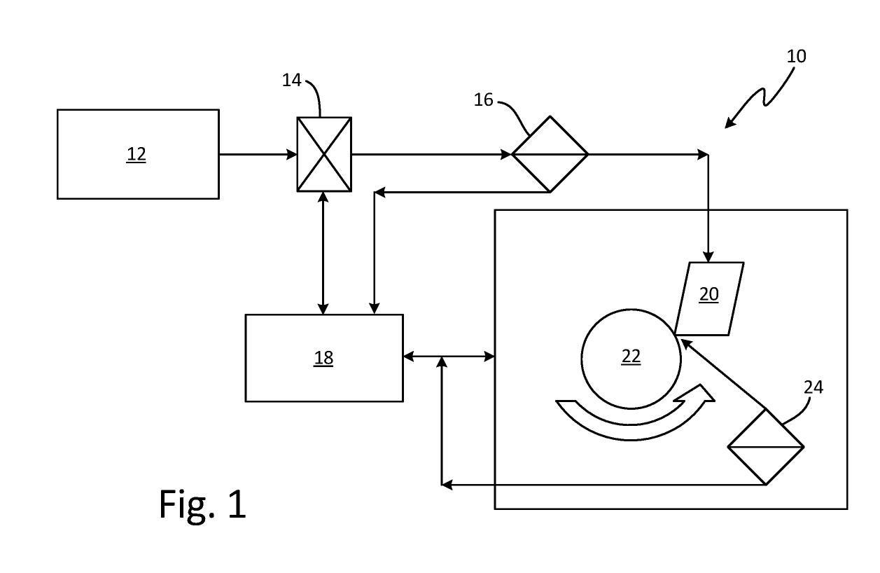

FIG. 1 is a schematic diagram of feedback-controlled cryogenic machining system 10. System 10 includes pressurized cryogenic fluid source 12, flow regulator 14, sensor 16, machining control unit (MCU) 18, cutting tool 20, work piece 22, and infrared (IR) sensor 24. Cryogenic fluid source 12 is connected to flow regulator 14 via piping or tubing. Sensor 16 is attached to piping or tubing downstream of flow regulator 14, and cutting tool 20 is downstream of sensor 16. Cutting tool 20 machines work piece 22. IR sensor 24 is aimed at the intersection of cutting tool 20 and work piece 22. MCU 18 communicates with sensor 16 and IR sensor 24, and can control flow regulator 14, cutting tool 20, and work piece 22.

In machining system 10, cutting tool 20 is cooled by a cryogenic fluid from cryogenic fluid source 12. Cryogenic coolants are typically liquefied gases, such as liquid nitrogen, hydrogen, or carbon dioxide. Liquid nitrogen is particularly useful for machining purposes as it can be used to chill a cutting tool without any environmental run off. Cryogenic fluid source 12 is a pressurized container holding a cryogenic fluid, such as liquid nitrogen, liquid carbon dioxide, or other cryogenic fluid used for cooling. Cryogenic fluid source 12 can be a Dewar flask or tank appropriate for holding a cryogenic coolant.

Cryogenic fluid source 12 is connected to flow regulator 14, which controls the flow of cryogenic fluid from cryogenic fluid source 12 and into the system. Flow regulator 14 can be, for instance, a valve system or a variable speed pump. Flow regulator 14 can be a hand set regulator, or automatically set by feedback control. Ideally, flow regulator 14 allows enough cryogenic fluid into the system to effectively cool cutting tool 20, but does not waste cryogenic fluid.

Downstream of flow regulator 14 are sensor 16. Sensor 16 can be one or more sensors configured to detect temperature, pressure, or flow rate of a cryogenic fluid that has flowed through flow regulator 14. Sensor 16 can be commercially available sensors, and can be in-line with the flow of cryogenic fluid. Sensor 16 should not obstruct flow of the cryogenic fluid. For instance, sensor 16 can clamp over tubing through which the cryogenic fluid flows.

Sensor 16 should be capable of detecting whether the cryogenic fluids' attributes fall outside of an optimal range for the cryogenic fluid. A pressure sensor can be configured to detect cryogenic fluid pressure and used to determine cryogenic feed line pulsations. A flow sensor can be configured to detect the flow rate of the cryogenic fluid and used to determine feed line pulsations. This information can help determine the optimal feed rate and properties of cryogenic fluid to cutting tool 20.

Cutting tool 20 is downstream of sensor 16. Cutting tool 20 can be a drill, turning insert, tap, broach cutter, abrasive tool, endmill, or threadmill. Cutting tool 20 can be used to drill, press, cut or otherwise shape work piece 22. A coolant, such as liquid nitrogen, can be applied to cutting tool 20 through two methods: internally, through the inside of cutting tool 20, or externally, through a nozzle to cutting tool 20. Depending on the needs of the specific system, a cryogenic fluid cooling cutting tool 20 can flash into a gas as it hits cutting tool 20, as it enters cutting tool 20, or as it exits cutting tool 20.

Machining system 10 can be used to change work piece 22 (a raw material, such as titanium alloys) into a desired shape. This is accomplished by a controlled material removal process altering work piece 22 with cutting tool 20. Instructions can be programmed through a user interface (not pictured) to direct the movement and action of cutting tool 20, and the placement and orientation of work piece 22.

Cutting tool 20 works on a surface of work piece 22 to shape work piece 22. Infrared (IR) sensor 24 monitors the surface of work piece 22 and the end of cutting tool 20. IR sensor 24 is in close proximity to where cutting tool 20 is working on work piece 22. IR sensor 24 optically monitors this area (sometimes referred to as the “cut zone”), including cutting tool 20 and the surface of work piece 22, detecting temperature variations. Temperature variations detected at the cut zone can show the state of cutting tool 20 and work piece 22. If temperature variations are outside of an optimal range, the work of cutting tool 20 can be altered by changing position or the process parameters of cutting tool 20. Additionally, IR sensor 24 can be used to detect heat released from cutting tool 20 as it works on work piece 22. Data collected by IR sensor 24 is sent to Machining control unit 18.

Machining control unit (MCU) 18 receives data from sensor 16 and IR sensor 24. MCU 18 can be an add-on to a larger machining control unit, which can be a computer numerical control or a more complex program designed to control the machining process as a whole. MCU 18 analyzes data, such as temperature, pressure, or flow rate data, from sensor 16. The control of temperature, pressure, and flow rate of the cryogenic fluid via flow regulator 14 prevents the cryogenic fluid from flashing to a gas before it cools cutting tool 20.

MCU 18 can be programmed so each measured property has an ideal range, and MCU 18 can adjust flow regulator 14 as required based on the incoming data. These adjustments allow for an efficient use of cryogenic fluid to cool cutting tool 20, but do not allow waste of cryogenic fluid. These adjustments can be made by MCU 18 automatically, or MCU 18 can notify a user of system 10 that adjustments need to be made.

MCU 18 can also analyze data provided by IR sensor 24 about cutting tool 20 and work piece 22, allowing for quantitative information on the state of cutting tool 20, including temperature change on the surface of work piece 22 being cut by cutting tool 20. This creates an environment where the user of machining system 10 is notified before cutting tool 20 is dulled, and increasing overall efficiency of the system.

Overall, feedback-controlled cryogenic machining system 10 uses inline sensor 16 to analyze the cryogenic fluid being delivered to cutting tool 20, set bounds for ideal temperature, pressure, and flow of the cryogenic fluid, and uses and IR sensor 24 to analyze temperature changes on the surface of work piece 22 and cutting tool 20. This information allows immediate adjustments by MCU 18 to the system, while machining is taking place, to optimize both the cryogenic cooling and the cutting of the work piece.

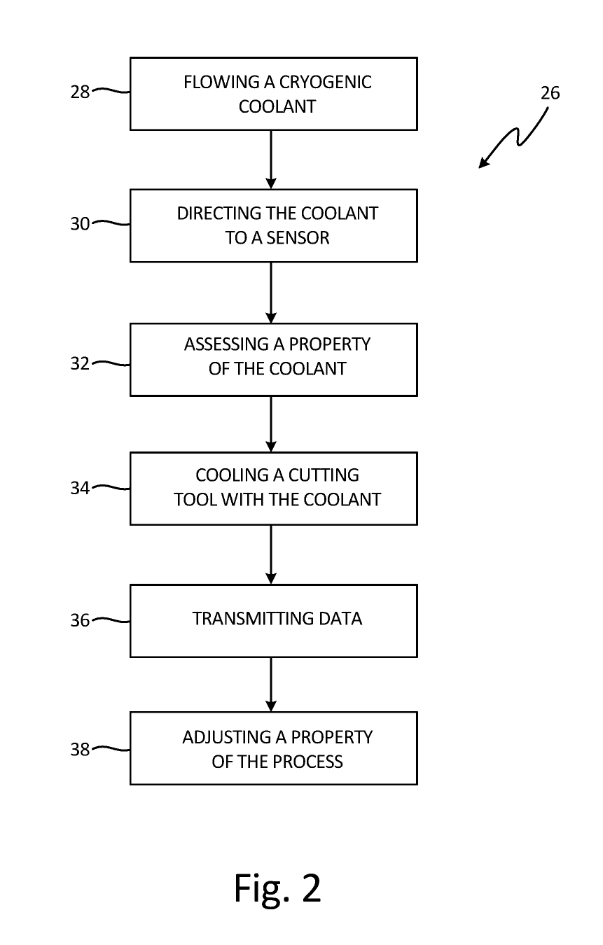

FIG. 2 is a flow diagram of method 26 of using a feedback-controlled cryogenic machining system. Method 26 begins with step 28, where a cryogenic fluid, such as liquid nitrogen, is flowed into the system from a cryogenic fluid source through a flow regulator. The source can be a Dewar flask or tank suitable for storing cryogenic fluid. The flow regulator can be a valve system or variable speed pump that controls flow of cryogenic fluid out of the source.

In step 30, the cryogenic fluid is flowed through one or more in line sensors. In step 32, the sensors assess temperature, pressure, flow rate, or any other metrics of interest. These properties show the state of the cryogenic fluid, and whether it is at ideal conditions or should be altered.

The cryogenic fluid is then flowed to a cutting tool in step 34, where it cools the cutting tool. The cryogenic fluid can either be applied to an external surface of the cutting tool through a nozzle, or it can be applied to one or more internal passages of the cutting tool. The cutting tool's lifespan is greatly increased by the cryogenic cooling.

While the cryogenic fluid is cooling the cutting tool, another sensor can be monitoring the work of the cutting tool on a work piece. This sensor can be an infrared (IR) sensor which monitors heat given off by both the cutting tool and the surface of the work piece. The data collected from the IR sensor can determine whether the flow of the cryogenic fluid is optimal for tool life, machining process parameters and for producing acceptable surface finish and metallurgy.

In step 36, data from the sensors is sent to a machining control unit. The machining control unit analyzes the data, which can include temperature, pressure, and flow rate information about the cryogenic fluid, and determines which conditions should be altered to optimize the cryogenic cooling, avoid early flash of cryogenic fluid to a gas, and allow for less waste of cryogenic fluid.

Finally, in step 38, the machining control unit communicates with the flow regulator to adjust the flow of cryogenic fluid into the machining system, if needed. The machining control unit can also adjust the cutting tool position and machining process parameters.

This feedback-controlled cryogenic machining system and method of using a feedback-controlled cryogenic machining system provide the user information regarding cryogenic fluid temperature, pressure and flow rate, all of which can be controlled by the feedback-controlled system. The system can make real-time adjustments based on the data it receives. This allows production yields which are better controlled and optimized, and provides real time data as machining processes are occurring.

Overall, this method results in an increased lifespan of the cutting tool by more effectively cooling it, improved quality control of the work piece product by determining when the cutting tool should be replaced, improved efficiency of cooling the cutting tool with cryogenic fluid by wasting less cryogenic coolant, and long term data collection and analysis for use in future machining processes.

### Discussion of Possible Embodiments

The following are non-exclusive descriptions of possible embodiments of the present invention.

A cryogenic machining system includes a cryogenic fluid source, a flow regulator downstream of the cryogenic fluid source, a machining control unit, at least one sensor downstream of the flow regulator, configured to assess cryogenic fluid and transmit data to the machining control unit, and a cutting tool downstream of the at least one sensor.

The system of the preceding paragraph can optionally include, additionally and/or alternatively, any one or more of the following features, configurations and/or additional components:

The system of claim 1 includes a work piece, wherein the cutting tool is configured to shape the work piece.

The at least one sensor is configured to assess flow velocity of the cryogenic fluid.

The at least one sensor is configured to assess pressure of the cryogenic fluid at the at least one sensor.

The at least one sensor is configured to assess temperature of the cryogenic fluid at the at least one sensor.

The at least one sensor is an infrared sensor configured to assess the cryogenic fluid cooling the cutting tool.

The at least one sensor configured to collect data relating to the cryogenic fluid.

The at least one sensor configured to transmit data to the machining control unit.

The machining control unit configured to control the flow regulator.

The machining control unit configured to control the action and placement of the cutting tool.

The machining control unit configured to control the movement and placement of the work piece.

The cutting tool is internally cooled by the cryogenic fluid.

The cutting tool is externally cooled by the cryogenic fluid.

A method of regulating a cryogenically cooled machining system includes flowing a cryogenic coolant through a flow regulator; directing the cryogenic fluid through at least one sensor; assessing at least one property of the cryogenic fluid with the at least one sensor; cooling a cutting tool with the cryogenic coolant; transmitting data about the at least one property of the cryogenic fluid from the sensor to a machining control unit; and adjusting at least one property of the cryogenic coolant based on the data transmitted to the machining control unit.

The method of the preceding paragraph can optionally include, additionally and/or alternatively, any one or more of the following features, configurations and/or additional components:

The at least one property is temperature.

The at least one property is pressure.

The at least one property is flow velocity.

The at least one property is infrared radiation.

The method includes adjusting motion of the cutting tool based on the data transmitted to the machining control unit.

The method includes adjusting placement of a work piece based on the data transmitted to the machining control unit.

While the invention has been described with reference to an exemplary embodiment(s), it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A cryogenic machining system comprising:
a cryogenic fluid source;
a flow regulator downstream of the cryogenic fluid source;
a machining control unit;
at least one sensor downstream of the flow regulator, the at least one sensor configured to assess cryogenic fluid and transmit data to the machining control unit; and
a cutting tool downstream of the at least one sensor.

2. The system of claim 1 and further comprising a work piece, wherein the cutting tool is configured to shape the work piece.

3. The system of claim 1, wherein the at least one sensor is configured to assess flow rate of the cryogenic fluid.

4. The system of claim 1, wherein the at least one sensor is configured to assess pressure of the cryogenic fluid.

5. The system of claim 1, wherein the at least one sensor is configured to assess temperature of the cryogenic fluid.

6. The system of claim 1, wherein the at least one sensor is an infrared sensor configured to assess the cutting tool.

7. The system of claim 1, the at least one sensor configured to collect data relating to the cryogenic fluid.

8. The system of claim 7, the at least one sensor configured to transmit data to the machining control unit.

9. The system of claim 1, the machining control unit configured to control the flow regulator.

10. The system of claim 1, the machining control unit configured to control action and placement of the cutting tool.

11. The system of claim 2, the machining control unit configured to control movement and placement of the work piece.

12. The system of claim 1, wherein the cutting tool is internally cooled by the cryogenic fluid.

13. The system of claim 1, wherein the cutting tool is externally cooled by the cryogenic fluid.

14. A method of regulating a cryogenically cooled machining system, the method comprising:
flowing a cryogenic coolant through a flow regulator;
directing the cryogenic fluid through at least one sensor;
assessing at least one property of the cryogenic fluid with the at least one sensor;
cooling a cutting tool with the cryogenic coolant;
transmitting data about the at least one property of the cryogenic fluid from the sensor to a machining control unit; and
adjusting at least one property of the cryogenic coolant based on the data transmitted to the machining control unit.

15. The method of claim 14, wherein the at least one property is temperature.

16. The method of claim 14, wherein the at least one property is pressure.

17. The method of claim 14, wherein the at least one property is flow velocity.

18. The method of claim 14, further comprising detecting infrared radiation near the cutting tool.

19. The method of claim 14, further comprising adjusting motion of the cutting tool based on the data transmitted to the machining control unit.

20. The method of claim 14, further comprising adjusting placement of a work piece based on the data transmitted to the machining control unit.
